(19) United States
(12) Patent Application Publication
(10) Pub. No.: US 2003/0126597 A1
(43) Pub. Date: Jul. 3, 2003

(54) On-screen stripe and other methods for delivering information that facilitate convergence of audio/visual programming and advertisements with internet and other media usage

(76) Inventors: Geoffrey Darby, Glen Ridge, NJ (US); Linda Ong-Safina, New York, NY (US); Cindy J. Kettler-Hitzig, New York, NY (US); Eli Noyes, San Francisco, CA (US); Scott Stein, New York, NY (US); Lawrence C.N. Laybourne, New York, NY (US)

Correspondence Address: HARRINGTON & SMITH, LLP, 4 RESEARCH DRIVE, SHELTON, CT, 06484-6212, US

(21) Appl. No.: 09/735,946

(22) Filed: Dec. 13, 2000

Related U.S. Application Data
(60) Provisional application No. 60/179,568, filed on Feb. 1, 2000.

(51) Int. Cl. H04N 7/173; H04N 7/025; H04N 7/20

(52) U.S. Cl. 725/32; 725/110; 725/68

(57) ABSTRACT

A method is disclosed for displaying a commercial to a television viewer. The method has a first step of: (a) transmitting a television signal such that a first area of a television monitor screen displays a commercial, and such that a visually distinct stripe runs horizontally across the bottom of the television monitor screen. The stripe displays information that is descriptive at least of an Internet address of a site that is related to goods or services depicted in the commercial. The method has a second step of: (b) either during the commercial or after the commercial, operating a device that provides Internet access to reach the site using the displayed information. In the preferred embodiment the television monitor screen has a total height, and the stripe has a height that comprises about 12% of the total height.

### CLAIM OF PRIORITY FROM A COPENDING PROVISIONAL PATENT APPLICATION

This patent application claims priority under 35 U.S.C. 119(e) from copending Provisional Patent Application No. 60/179,568, filed Feb. 1, 2000, the disclosure of which is incorporated by reference herein in its entirety.

### FIELD OF THE INVENTION

This invention relates generally to novel methods and systems for delivering information to viewers, and more particularly relates to audio/visual programming, to the Internet and other on-line services, and to a convergence and synergy of television programming and the Internet and other on-line services.

### BACKGROUND OF THE INVENTION

Television programming is well known and wide spread. Traditionally, commercial television programming has been comprised of entertainment and informative segments that are typically referred to as “programs” or “shows”. The segments, with few exceptions, are of predetermined duration (typically one half hour or some multiple of one half hour in duration). During a segment and between segments it is conventional practice to present one or more advertisements or “commercials” that are descriptive of goods and/or services that are associated with sponsor(s) of the segment(s) or promotions that are descriptive of the goods, services, programs or shows that are associated with the source of the programming. The organization that is the source of the programming (i.e., the programmer) typically derives income from the sponsors in exchange for presenting their advertisements to viewers of the entertainment and informative segments.

With the recent explosive rise in the use of the Internet and other on-line services it has become known to display, with a television segment that is currently being viewed, textual input from the viewers, via their computers and an Internet server or a site, such as a “chat room”. For example, a system known as Cod-i-chat™ (available from Callaway GraphicSoftware (callawaygs.com)) provides an on-screen ability to roll (vertically) or crawl (horizontally) Internet-derived chat names and text with a television segment that is currently being transmitted to viewers. In this manner it is said that one is enabled to involve viewers with the programming. In one application of this technique, a third of the screen is dedicated to displaying the chat names and text, with the remaining two thirds displaying the television programming. For the case of prerecorded broadcasts of some programs, an interactive, substantially real-time Internet chat “conversation” between viewers/Internet users and cast members can occur, with the conversation text being displayed to all viewers.

While this technique may represent a first step towards integrating television programming with Internet usage, it does not address the needs of advertisers, sponsors and programmers to present multiple forms of information to viewers, thereby achieving a synergy between, for example, television and the Internet, and other on-line services, thereby achieving a convergence with the viewers of their advertisements and, ideally, the consumers of their products, services and programs.

### OBJECTS AND ADVANTAGES OF THE INVENTION

It is a first object and advantage of this invention to provide a methods of presenting multiple forms of information to viewers such that content providers, advertisers, sponsors, promoters and/or programmers can achieve synergy of presentation.

It is a further object and advantage of this invention to provide methods by which content providers, advertisers, promotors, sponsors and/or programmers may promote convergent and divergent behavior by viewers of their content, advertisements, promotions and/or programming.

It is a further object and advantage of this invention to provide a predetermined onscreen area or window, referred to herein for convenience as a stripe (or in some contexts as a “strip”), that may be present during programming and, with or without interruption, during commercials, wherein during a commercial an advertiser is provided a capability to display other information to viewers, such as, but not limited to, information for directing the viewers to the advertiser's Internet site(s), as well as relevant and special promotional messages.

It is a further object and advantage of this invention to provide a strip that is present during programming and, with or without interruption, during commercials, wherein during a commercial an advertiser is provided a capability to display other information to viewers, such as, but not limited to, information directing the viewers to the advertiser's Internet site(s), as well as relevant and special promotional messages, that may be fixed or periodically or continuously updated or otherwise changed, without changing the information displayed outside of the stripe.

It is another object and advantage of this invention to provide a stripe that adds value to the programmer, advertiser, sponsor and/or viewer, in that the stripe provides, among other things: branding for the programmer; a navigational element for the viewer; incentives for the viewer to use other media; information to the viewer, including information that can be regionalized, personalized, and/or updated continuously, in real-time or periodically.

It is another object and advantage of this invention to provide a predetermined on-screen area whereby the programmer is enabled to display other information to viewers, such as, but not limited to, information for directing the viewers to the programmer's Internet site(s), information for directing the viewers to other Internet site(s) that are relevant to programming, as well as running commentary.

### SUMMARY OF THE INVENTION

The foregoing and other problems are overcome and the objects of the invention are realized by methods and apparatus in accordance with embodiments of this invention.

In accordance with one aspect of these teachings a method is disclosed for displaying a commercial or a promotional message to a viewer of a viewing appliance. A viewing appliance may include, but need not be limited to, a television monitor, a computer monitor receiving a video feed, a wireless device having a display, etc. In a presently preferred embodiment the method provides for transmitting a television signal such that a first area of a television monitor screen displays a commercial, and such that a visually distinct window or stripe runs horizontally across the bottom of the television monitor screen, wherein the stripe displays information that is related to goods or services of the sponsor, and which may include an Internet or on-line service address of a site that is related to the sponsor, its goods or services, or the goods or services depicted in the commercial.

The method may have a second step of, either during the commercial or after the commercial, operating a device that provides Internet access to reach the site using the displayed information.

In the preferred embodiment the television monitor screen has a total height, and the stripe has a height that comprises about 12% of the total height.

At some subsequent time a step is executed of transmitting the television signal such that the first area of the television monitor screen displays programming content; as well as a step of displaying textual information in the stripe, the textual information being received from the Internet or from some other source. The other information could be, by example, commentary on some aspect of the program being viewed.

The method may further display additional information in the stripe. The additional information may be descriptive of an Internet address of another site that is also related to goods or services depicted in the commercial, and/or it may be descriptive of at least one promotional message from an advertiser, and/or it may be descriptive of a logo associated with an advertiser, and/or it may be descriptive of a logo of goods or services associated with a provider of the television signal. During the commercial the content of the information displayed in the stripe could be varied.

During the time that the first area of the television monitor screen is displaying the commercial, the method may further display the further information as an identification of the advertiser, such as a logo, wherein the identification is displayed such that it extends beyond a top border of the stripe into the first area.

In addition, the further information displayed in the stripe may be selected at least in part as a function of a type of program, and/or a type of viewing audience of the program, with which the commercial appears.

The information appearing in the stripe may be relevant to all viewers, or it may be customized to be pertinent to viewers within a predetermined region, or it may be personalized to be pertinent to a particular viewer.

The information appearing in the stripe may be fixed or it may be updated, or otherwise changed periodically, without affecting the commercial or the content that it is displayed with.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is simplified block diagram of a system that is suitable for practicing this invention;

FIG. 2A is a depiction of a television screen that is partitioned between a conventional programming area and another area, referred to herein for convenience as a “stripe”;

FIG. 2B is an example of a commercial being displayed in the programming area, along with supplemental information (e.g., the advertiser's Internet address) being displayed in the stripe;

FIG. 3 is a depiction of one arrangement of information within the stripe during a commercial; and

FIG. 4 is a block diagram of a presently preferred embodiment of the system.

### DETAILED DESCRIPTION OF THE INVENTION

This invention will be described in the context of, but is not limited to, providing television signals containing programming, promotional messages and advertisements, in conjunction with an information-containing stripe that is always present and that covers a predetermined portion of the screen. The information appearing in the stripe may be relevant to all viewers, or it may be customized to be pertinent to viewers within a predetermined region, or it may be personalized to be pertinent to a particular viewer or a group of viewers. The information appearing in the stripe may pre-recorded, or it may be provided in real-time, or it may be provided in a time-delayed or other manner. The control of the content of the stripe may be maintained by the source of the programming, or it may relinquished, perhaps as a value-added feature, to an advertiser having a commercial that is displayed in conjunction with the stripe. In general, the stripe adds value for the advertiser and to the advertisement, as it enables additional information to be displayed regarding a product or a service being advertised, and further enables information to be updated and revised, either periodically or continuously, after the commercial is produced and aired. The stripe can contain an Internet or other on-line service address of a server associated with the advertiser, and/or a server of the programmer, and/or the server of some other party. The stripe can be employed to direct a viewer to a cobranded partner's site.

While the content of the stripe is discussed below in the context of directing a viewer to an Internet site, all such references to Internet sites and addresses should be understood to also include other on-line sites, such as, but not limited to, Internet Service Provider and Internet Portal sites, such as, for example, America Online (“AOL”).

The stripe can function as well as a “billboard” that is displayed during a program, and could present a message such as “This program is brought to you by Advertiser”, “coming up next . . . ”

The stripe may be passive or active. In an active stripe, if using an interactive video mode, the viewer is enabled to “click” on a URL or on a Hyperlink displayed in the stripe to reach the associated site, (e.g., the general www site of an advertiser (www.advertiser.com)), or to reach some sub-site related to the product or service being advertised (e.g., www.advertiser.com/product). In this type of environment the preferences exhibited by, and the destination(s) selected by, the viewer can be considered, and the content of the stripe tailored over time to that particular viewer's personal interests and preferences. In addition, the strip may be designed to be referenced by the programming and/or advertising, or vice versa. For example, a commercial may reference the stripe as a source of additional information, or vice versa.

The indicated destination addresses, Hyperlinks and sites can be predetermined to determine the number of ‘hits’ generated by the stripe itself, such as by setting up a URL that is only displayed in or that is only reachable through the stripe.

This invention further provides an ability to perform “media casting”, wherein by example the stripe has its own feed (separate from the program/advertising feed), and where multiple information and viewing appliances may be responsive to receiving the stripe transmission for displaying same, and/or for possibly printing out coupons or other promotional materials, as well as informational materials, that are related to an advertiser, to a programmer's promotional message, or to the content of the programming itself.

In general, the stripe, which is preferably always present on the screen, provides a powerful branding tool, and readily identifies the channel as belonging to a particular programmer. The use of the stripe promotes convergence between different media (e.g., between cable television and the Internet). The use of the stripe can also enable a viewer to reach a location wherein pathways exist to multiple, contextually-related sites, as well pointers to other media and communication types, such as radio, print, telephone, facsimile, e-mail, etc.

The stripe can also display a logo, scheme, or an animation that becomes associated with the stripe and the programmer. By changing color, size, movement, etc., the animation may act as a navigational aid to the viewer. The animation or logo map appear periodically or continuously or sporadically, as the programmer or the advertiser sees fit. In addition, any information displayed in the stripe, including any logo or animation, can be displayed using special effects such as “custom wipes”, “bumpers”, or other devices or effects known in the art.

The stripe can also be used to display a video with or without corresponding audio.

In general, however, the teachings of this invention relate to any viewing appliance, not necessarily to just a television monitor. Other examples of suitable viewing appliances include, but are not limited to, a computer having a monitor that displays a video feed, a monitor that displays video feed, and a wireless device having a display for displaying a video signal.

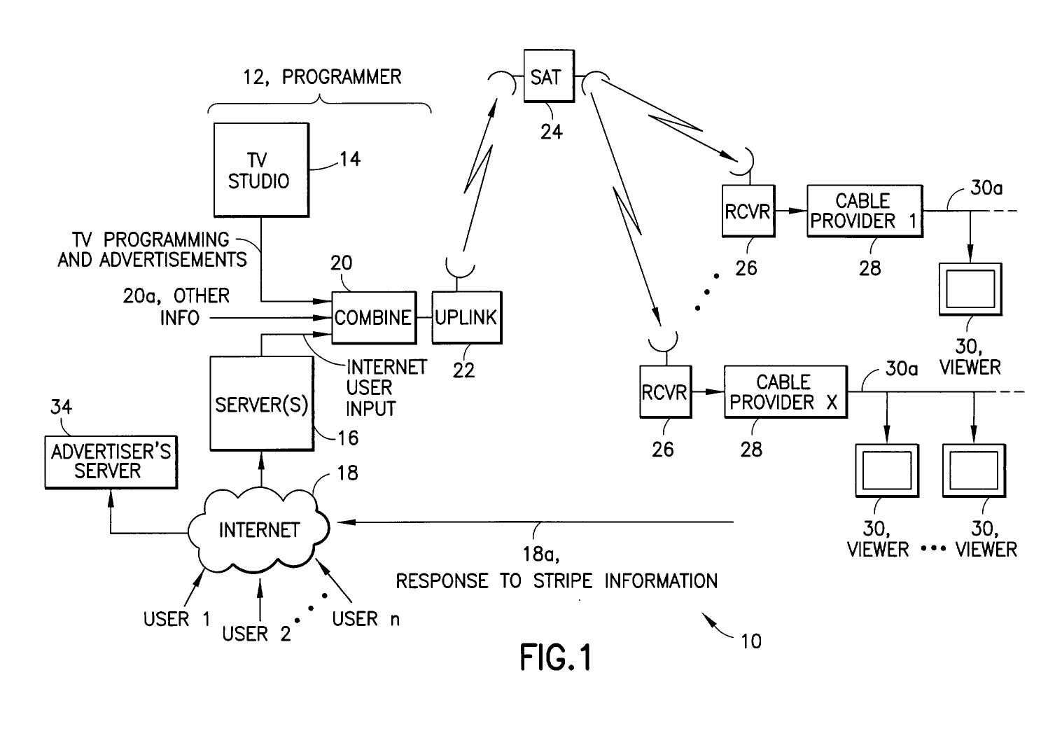

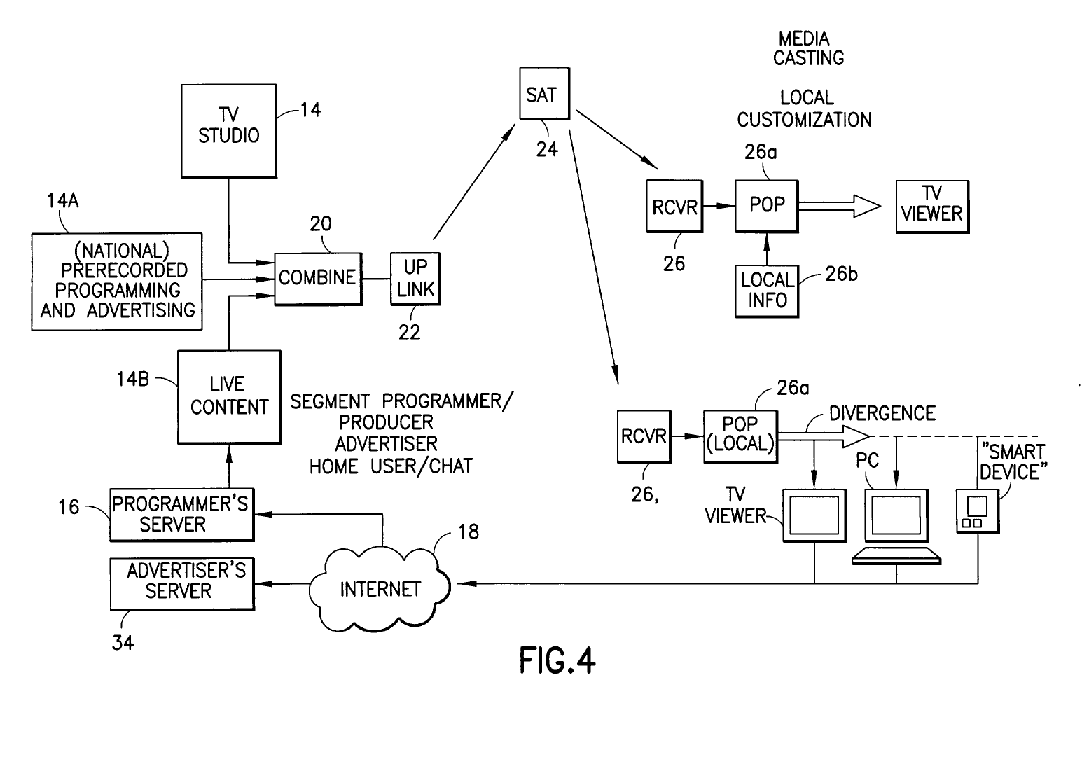

FIG. 1 is a simplified, general block diagram of a system 10 that is suitable for practicing this invention using television. The embodiment of the system shown in FIG. 4 will be discussed subsequently.

The system 10 includes a programmer 12 comprising a TV studio 14 that outputs TV programming, promotions and advertisements. The TV programming may be live or pre-recorded, while the advertisements are typically pre-recorded. In this embodiment of the invention the programmer 12 also includes or is coupled to one or more servers 16 that are in turn coupled to the Internet 18. The output of the servers 16 is Internet-derived user input from a plurality of Internet users (user 1 . . . user n). A combiner 20 may be coupled to both the output of the TV studio 14 and the server 16 for merging or combining these two inputs into a unified programming/Internet user input video signal.

In a preferred embodiment of this invention the combiner 20 also receives as an input other information 20a, the other information 20a being descriptive of at least one of: (a) information that is descriptive of an Internet address of a site that is related to goods or services depicted in the commercial; (b) an Internet address of another site that is also related to goods or services depicted in the commercial; (c) at least one promotional message from the advertiser; (d) a logo associated with an advertiser; and (e) a logo associated with the programmer 12. Further in accordance with the teachings herein, where a commercial shows a plurality of products, the other information 20a may be descriptive of a provider of each of the plurality of products.

The video signal, along with the associated audio information, can be transmitted via an uplink 22 to a satellite 24. Typically the satellite 24 will be a geosynchronous-type satellite that provides coverage of a predetermined portion of the earths surface.

Multiple satellites and uplinks could be used to provide wider coverage. In the presently preferred embodiment there are actually two uplink feeds, one for the East Coast of the United States and another for the West Coast. The satellite 24 broadcasts the television signal back to the Earth where it is received by authorized receivers 26. By example, individual ones of the receivers 26 may be associated with individual ones of television providers 1-x, such as cable television providers 28. In this example cable television providers 28 have cable lines 30a for providing the received broadcast video signal to individual ones of viewers via television monitors 30.

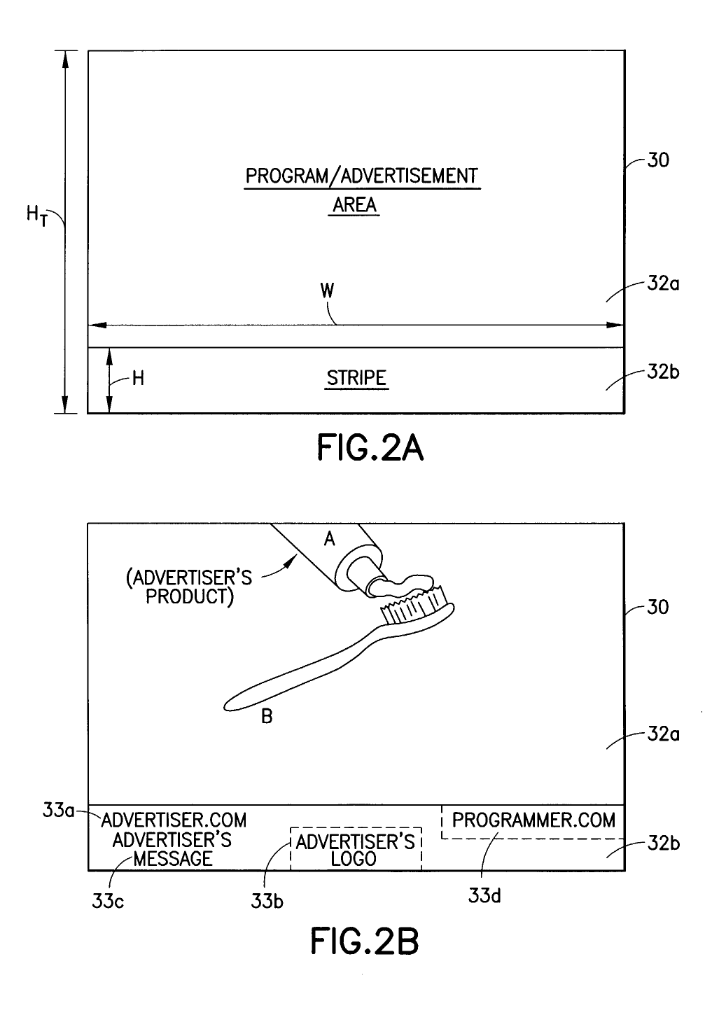

In accordance with an aspect of this invention, and referring now to FIG. 2a, the display screen of each of the television monitors 30 is divided or partitioned into a program/advertisement area 32a and another area, referred to herein as the stripe 32b. The stripe 32b is preferably arranged horizontally at the lower edge of the program/advertisement area 32a, and has a width (W) that is nominally equal to the width of the program advertisement area and a height (H) that is preferably less than 15% of the total height H_{T}. More preferably, the height of the stripe 32a is approximately 12% of the total height display screen area.

It should be realized that this orientation and size of the stripe 32b is illustrative of a presently preferred embodiment of this invention, and that other orientations and sizes may be used. For example, the stripe could be disposed in a vertical fashion on the left or right side of the screen, or it could be located at the top as opposed to the bottom of the screen.

Further in accordance with this aspect of the invention and referring now to FIG. 2b, an exemplary advertisement depicts an advertiser's product (A) within the program/advertisement area 32a and, simultaneously, there is depicted in the stripe 32b an Internet address for the advertiser (e.g., the advertiser's Universal Resource Locator (URL), such as ‘advertiser.com’ 33a). Optionally, the advertiser's logo 33b, such as a graphical image associated with the advertiser or advertiser's brand, can also be displayed in the stripe 32b. It is also within the scope of the teachings of this invention to display an advertiser message 33c in the stripe 32b. Also as an option, an Internet address of the programmer 12 (‘programmer.com’ 33d), and/or a logo of the programmer 12, can be displayed in a predetermined location within the stripe 32b. In this manner the advertiser is enabled to present the viewer with supplemental information related to the advertiser and/or the specific product (A) being advertised. As such, it can be appreciated that the combiner 20 of FIG. 1 operates so as to combine the other information 20a such that it is displayed with the stripe 32b.

Referring again to FIG. 1, in response to the information found in the stripe 32b a particular viewer may contact the advertiser's Internet server 34 via the Internet 18 (indicated generally by the line 18a).

For example, the advertiser's message 33c may be a promotional message that encourages viewers to contact the advertiser's Internet site 34 (see FIG. 1) to receive additional information about the product (A). This additional information may include, but is not limited to, ingredients, place of origin, specifications, usage or assembly instructions, availability, points of purchase, price and discounts, dosage instructions, known side effects, etc. The viewer could also be provided with a discount coupon, and/or location(s) where the product is available.

The stripe 32b can thus be seen to function as a multi-purpose informational device and navigational aid that facilitates and encourages convergent and divergent behavior in viewers of the programming and advertisement of the programmer 12. By “convergent” behavior it is meant that the viewer acts in such a manner as to integrate or merge her or his television viewing with Internet usage. More particularly, the stripe 32b can be seen to function to provide a convergence for advertising, wherein the presentation of commercials on a television monitor screen converges with an ability of a viewer to access the advertiser or some other party that is related in some way to the subject matter of the commercial. The strip 32b thus facilitates multi-tasking, thereby enabling efficient use of numerous media.

In a presently preferred embodiment it is desirable to display the stripe 32b during both regular programming and also during advertisements (as well as during promotional messages), thereby presenting a persistent and consistent network design element that becomes associated with the output of the programmer 12. The stripe 32b may be ‘on’ 24 hours a day, seven days a week. This network design element adds value to the advertiser as well, as a viewer who is changing channels will instinctively know that they have selected the programmer's channel, even during a commercial break, because the stripe 32b will be prominently displayed.

In general, the stripe 32b enhances the viewing experience by adding valuable information, including the addresses of Internet sites (universal resource locators (URLs)), relevant tips and messages related to programming or advertising, as well as promotional messages. During programming and promotion the messaging in the stripe 32b may include information to direct the viewer to the programmer's Internet site or sites, and may as well provide a running commentary. During commercials, the stripe 32 may instead provide the advertiser's URL, as well as relevant promotional messaging.

The stripe 32b may also include such features as live Internet chats as well as animation.

It should be appreciated that the advertiser may wish to enable, for some consideration, manufacturers or distributors of related goods or services to also provide their Internet URLs in the stripe 32b. As but one example, and referring again to FIG. 2b, if the advertiser's product is assumed to be product A, then the manufacturer of related product B may also wish to provide their Internet-related contact information. In other cases, and assuming for example that a pharmaceutical product is being advertised, the stripe 32b may provide the Internet address of an organization of specialist medical doctors who treat a related disease, or the stripe 32b may provide the Internet address of a National organization dedicated to providing information about and raising research funds for the related disease.

In light of these various cases it should be appreciated that the stripe 32b need not be limited, during a commercial, to providing information only about the advertiser.

It should also be appreciated that the use of the stripe 32b does not require that the commercial itself be specially designed or produced to be viewed with the stripe 32b (although it may be), thereby enabling the same commercial to be viewed on the network of the programmer 12 as well as on the network of another programmer that does not use the stripe 32b.

In one embodiment the viewer sees the messages and URLS in the stripe 32b and then uses some convenient means to gain access to the advertiser's Internet site 34 via the Internet 18. In another embodiment, one that assumes some type of interactive capability between the viewer and the television monitor 30, the viewer may be enabled to point and click directly to a displayed URL to gain access to that Internet location. In this case, some further portion of the stripe 32b could be used to provide the viewer with the desired on-screen information from the advertiser's Internet site.

While described above in the context of specific types of hardware, specific relative sizes of the program/advertisement area 32a and stripe area 32b, specific types of stripe content and information, etc., it should be realized that these and other specific recitations are provided to illustrate and to reflect presently preferred embodiments of this invention. For example, the teachings of this invention can be applied to other than just programming content and advertisements that are delivered by cable television providers, as network broadcast providers could benefit as well from the teachings of this invention.

Furthermore, the stripe 32b could convey other types of contact information for the advertiser, such as an e-mail address, a telephone number, and/or a mailing address. Also, the information displayed within the stripe 32b could change during the progress of the commercial. For example, when the commercial begins the stripe 32b may display the advertiser's Internet address, then change to displaying a promotional message, then change to displaying some other desired type of information, such as an announcement. Further in this regard, and assuming that the commercial concerns a newly released film, the stripe 32b may first display a world wide web (www) address associated with the film (e.g., www.studio_name.com/film name), followed later by a promotional message (e.g., “Appearing in theaters starting March 1”), followed later by an announcement (e.g., “Live Internet chat with stars at 8:00 pm at www.programmer_name.com/film_name”).

It is also within the scope of these teachings to make the information content of the stripe 32b at least partially a function of the type of program within which the commercial appears. By example, and assuming that the program is a financial program, then the stripe 32b may also display during the commercial a current stock price of the advertiser's company (e.g. “XYZ 44⅞”), or some recent news released by the advertiser's company (e.g., “XYZ Company announces record earnings”), or some other information deemed to be of particular interest to the expected viewing audience of the program.

The background color of the stripe 32b could be constant (e.g., white), or it may be any desired color. Preferably, the stripe 32b is displayed so as to visually distinct from the program/advertisement area 32a. The promotional and other messages 33c could be provided in one language or in two or more languages.

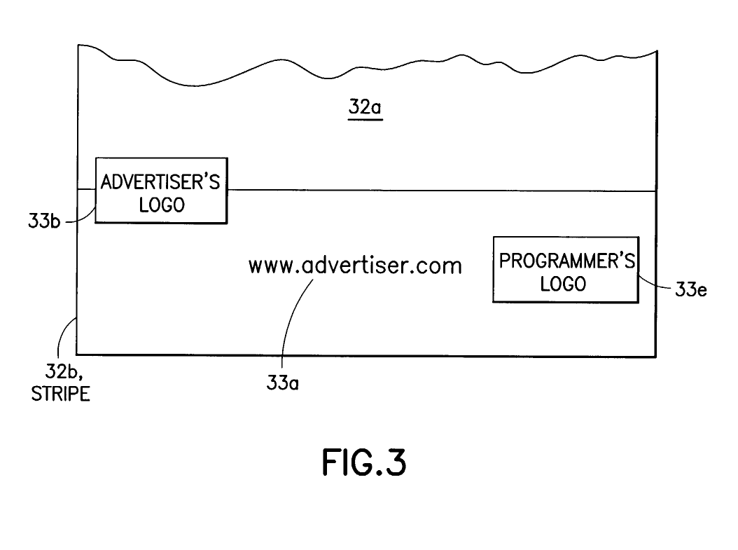

It is also within the scope of these teachings, as depicted in FIG. 3, to cause some portion of the information in the stripe 32b, such as the advertiser's logo, to overlap the border between the area of the stripe 32b and the program/advertisement area 32a, thereby visually tying the informational content of the stripe 32b with the content of the commercial appearing in the area 32a. FIG. 3 also depicts one preferred arrangement of the information within the stripe 32b, wherein it can be seen that a logo 33e of the programmer 12 is shown in the right-most portion of the stripe (this may always be present in this location), the logo 33b of the current advertiser appears in the left-most portion of the stripe 32a (slightly overlapped with the program/advertisement area 32a), and some other information, such as the advertiser's www address located in the center of the stripe 32b.

The content of the stripe 32b can be entered by an operator in real-time, or it can be separately pre-recorded and then merged with the commercial when the commercial is run, or it can be recorded onto the recording of the commercial and the two then played together. As was noted above, the programmer 12 may enable the advertiser or some other party to temporarily control the content of the stripe 32b.

One suitable unit for generating the stripe 32b is known as FXDeko™, which is available from Pinnacle Systems, Inc. (www.pinnaclesys.com). Other types of hardware and software systems may be used as well for this purpose.

FIG. 4 illustrates a further embodiment of the system 10, wherein elements that correspond to those found in FIG. 1 are numbered accordingly. FIG. 4 is useful in explaining the technology used to dynamically generate the stripe 32b.

First with regard to the input to the stripe 32b, the messages may be created at the time a contract is sold, and the text copy (billboard) and graphical elements (logos) are created or obtained. This data concerning the commercial (metadata) is stored in the program scheduling and sales database (traffic system). These elements and functions are generally associated with the pre-recorded block 14A in FIG. 4.

With regard to the live content block 14B, the stripe input can be generated from a human operator, or by a software component that extracts data from the web, from e-mail, from chat, or from other sources including databases. The obtained data can then be inserted into an on-air program via a real-time datastream, which may encoded similarly to the pre-recorded or pre-formatted input referred to above.

For a dynamic transmission system, when the commercial is due to run, a software component (the parser) looks forward in the day's traffic log, and extracts the metadata about that commercial. This metadata is encoded into a serial data stream for insertion into a digital channel associated with the video signal itself. The datastream is sent to a Network Origination Center (NOC), extracted from the video signal, and sent to an insertion device (CG).

With regard to the on-air display, the character generator runs under software control to generate its text and graphical messages through automation. A particular layer of automation is signaled by an occurrence of an incoming datastream. The datastream invokes moving video, audio and text messages to supplement the branding and other messaging of the commercial.

With regard to feedback, the system 10 compares the time when messages were generated in the on-air television signal of the stripe 32b, and the resultant spike in web, telephone or other interactive traffic at various control points. Metrics of interest to advertisers allow a fine-tuning of the reach and effectiveness of the messaging.

In an exemplary first reception scenario, wherein local customization of the stripe 32b content is accomplished, the receiver 26 provides the received signal to a point-of-presence (POP) 26a wherein locally generated information 26b is inserted before providing the signal to the home TV viewer.

In an exemplary second reception scenario, referred to as divergence, a local POP 26a provides the signal to a TV viewer, to a PC viewer, and to a user of a wireless ‘smart device’. In this case all or at least some of these devices are coupled to the Internet 18, whereby the feedback signal is generated and monitored to correlate hits with the informational content of the stripe 32b.

It should be appreciated that while the invention has been particularly shown and described with respect to preferred embodiments thereof, it will be understood by those skilled in the art that changes in form and details may be made therein without departing from the scope and spirit of the invention.

What is claimed is:

1. A method for providing information to a television viewer, comprising steps of:
transmitting a television signal such that a first area of a television monitor screen displays programs and advertisements, and a second area of the television monitor screen displays other information; and, optionally,
during a time that the first area of the television monitor screen is displaying an advertisement for an advertiser, displaying information in said second area for specifying an address of a location in a global data communication system where the advertiser can be contacted.

2. A method for providing information to a television viewer, comprising steps of:
transmitting a television signal such that a first area of a television monitor screen displays programs and advertisements, and a second area of the television monitor screen displays other information; and
during a time that the first area of the television monitor screen is displaying an advertisement for an advertiser, displaying in said second area the other information for specifying a URL of the advertiser for enabling a viewer to contact the advertiser through the Internet.

3. A method as in claim 2, wherein the second area is displayed in the form of a stripe that runs across a lower portion of the television monitor screen.

4. A method as in claim 3, wherein the television monitor screen has a total height, and wherein the second area has a height that comprises about 12% of the total height.

5. A method as in claim 2, wherein during a time that the first area of the television monitor screen is displaying a program, displaying textual information in said second area that is received from the Internet.

6. A method as in claim 2, and after transitioning from the time that the first area of the television monitor screen is displaying the advertisement to a time that the first area is displaying programming content, continuing to display said second area.

7. A method as in claim 2, wherein during the time that the first area of the television monitor screen is displaying the advertisement, displaying in said second area at least one other URL.

8. A method as in claim 2, wherein during the time that the first area of the television monitor screen is displaying the advertisement, displaying in said second area at least one promotional message from the advertiser.

9. A method as in claim 2, wherein during the time that the first area of the television monitor screen is displaying the advertisement, displaying in said second area a logo associated with the advertiser.

10. A method as in claim 2, wherein during the time that the first area of the television monitor screen is displaying the advertisement, displaying in said second area a logo associated with a provider of the television signal.

11. A method as in claim 2, wherein during the time that the first area of the television monitor screen is displaying the advertisement, the advertisement showing a plurality of products, displaying in said second area other information for identifying a provider of each of said plurality of products.

12. A method as in claim 2, wherein during the time that the first area of the television monitor screen is displaying the advertisement, the advertisement showing a plurality of products, displaying in said second area other information for identifying a URL of a provider of each of said plurality of products.

13. A method for displaying a commercial to a television viewer, comprising steps of:
transmitting a television signal such that a first area of a television monitor screen displays a commercial and such that a visually distinct stripe runs horizontally across the bottom of the television monitor screen, the stripe displaying information that is descriptive at least of an Internet address of a site that is related to goods or services depicted in the commercial; and
operating a device that provides Internet access to reach the site using the displayed information.

14. A method as in claim 13, wherein the television monitor screen has a total height, and wherein the stripe has a height that comprises about 12% of the total height.

15. A method as in claim 13, and further comprising steps of:
subsequently transmitting the television signal such that the first area of the television monitor screen displays programming content; and
displaying textual information in said stripe, the textual information being received from the Internet.

16. A method as in claim 13, wherein during the time that the first area of the television monitor screen is displaying the commercial, displaying further information in said stripe, the further information being descriptive of an Internet address of another site that is also related to goods or services depicted in the commercial.

17. A method as in claim 13, wherein during the time that the first area of the television monitor screen is displaying the commercial, displaying further information in said stripe, the further information being descriptive of at least one promotional message from an advertiser.

18. A method as in claim 13, wherein during the time that the first area of the television monitor screen is displaying the commercial, displaying further information in said stripe, the further information being descriptive of a logo associated with an advertiser.

19. A method as in claim 13, wherein during the time that the first area of the television monitor screen is displaying the commercial, displaying further information in said stripe, the further information being descriptive of a logo associated with a provider of the television signal.

20. A method as in claim 13, wherein during the time that the first area of the television monitor screen is displaying the commercial, the commercial showing a plurality of products, displaying further information in said stripe, the further information being descriptive of a provider of each of said plurality of products.

21. A method as in claim 13, wherein during the time that the first area of the television monitor screen is displaying the commercial, the commercial showing a plurality of products, displaying further information in said stripe, the further information identifying a URL of a provider of each of said plurality of products.

22. A method as in claim 13, wherein during the time that the first area of the television monitor screen is displaying the commercial, changing at least once the content of at least some of the information displayed in said stripe.

23. A method as in claim 13, wherein during the time that the first area of the television monitor screen is displaying the commercial, displaying further information in said stripe, the further information comprising an identification of the advertiser, the identification being displayed such that it extends beyond a top border of said stripe into the first area.

24. A method as in claim 13, wherein during the time that the first area of the television monitor screen is displaying the commercial, displaying further information in said stripe, the further information being selected at least in part as a function of a type of program with which the commercial appears.

25. A method as in claim 13, wherein during the time that the first area of the television monitor screen is displaying the commercial, displaying further information in said stripe, the further information being selected at least in part as a function of a type of viewing audience of a program with which the commercial appears.
